(19) United States
(12) Patent Application Publication
(10) Pub. No.: US 2014/0359533 A1
(43) Pub. Date: Dec. 4, 2014

(54) DISPLAY APPARATUS AND CONTROL METHOD THEREOF

(71) Applicant: SAMSUNG ELECTRONICS CO., LTD., Suwon-si (KR)

(72) Inventors: Cheul-hee HAHM, Seongnam-si (KR); Jung-rae KIM, Suwon-si (KR); Tae-young LEE, Suwon-si (KR)

(73) Assignee: SAMSUNG ELECTRONICS CO., LTD., Suwon-si (KR)

(21) Appl. No.: 14/243,936

(22) Filed: Apr. 3, 2014

(30) Foreign Application Priority Data
May 31, 2013 (KR) 10-2013-0062290

(51) Int. Cl. G06F 3/0481

(52) U.S. Cl. CPC G06F 3/04817
USPC 715/838

(57) ABSTRACT

A display apparatus is disclosed. A display apparatus comprises a display configured to display a thumbnail page including at least one thumbnail image, a user interface configured to receive a thumbnail page turn command, a storage, and a controller configured to generate and store in advance image information relating to at least one thumbnail page arranged in a page turning direction and at last one thumbnail page arranged in an opposite direction to the page turning direction, based on a currently-displayed thumbnail page, and generate a thumbnail page to be displayed according to the thumbnail page turn command based on the image information stored in the storage.

### CROSS-REFERENCE TO RELATED APPLICATIONS

This application claims priority from Korean Patent Application No. 10-2013-0062290, filed on May 31, 2013, in the Korean Intellectual Property Office, the disclosure of which is incorporated herein by reference, in its entirety.

### BACKGROUND

1. Field

The exemplary embodiments relate to a display apparatus and a control method thereof. More particularly, the exemplary embodiments relate to a display apparatus, capable of providing a thumbnail image, and a control method thereof.

2. Description of the Related Art

With development of electronic technologies, various types of display devices (or apparatuses) are being invented. Especially, display devices, such as TV sets, personal computers (PCs), laptop computers, table PCs, mobile phones, MP3 players and the like, have sufficiently penetrated the market so as to be used in most homes.

In recent times, to meet users' needs of newer and more various functions, a digital TV, a tablet PC or a portable terminal such as a mobile phone is providing a thumbnail browser screen, on which various accessible images can be immediately be searched fast.

In the related art, only a thumbnail bitmap of a page that a user currently desires to view is extracted and stored in a cache area. Accordingly, to provide a new page in response to turning (changing, shifting) of the thumbnail page, files have to be received from an external device and decoded in order to extract bitmap data. This process requires a considerably long period of time.

### SUMMARY

Exemplary embodiments overcome the above disadvantages and other disadvantages not described above. Also, the exemplary embodiments are not required to overcome the disadvantages described above, and an exemplary embodiment may not overcome any of the problems or disadvantages described above.

In accordance with one exemplary embodiment, in order to achieve the aspects and other advantages, there is provided a display apparatus including a display configured to display a thumbnail page having at least one thumbnail image, a user interface configured to receive a thumbnail page turn command, a storage, and a controller configured to generate and store in advance image information relating to at least one thumbnail page arranged in a page turning direction and to generate and store in advance at last one thumbnail page arranged in an opposite direction to the page turning direction, based on a currently-displayed thumbnail page, and generate a thumbnail page to be displayed according to the thumbnail page turn command based on the stored image information.

The controller may further store image information relating to the currently-displayed thumbnail page in the storage.

The controller may generate and store the image information related to the thumbnail pages such that the number of thumbnail pages arranged in the page turning direction is greater than the number of thumbnail pages arranged in the opposite direction.

In response to the currently-displayed thumbnail page being the last page, the at least one thumbnail page arranged in the page turning direction may be a start page. In response to the currently-displayed thumbnail page being the start page, the at least one thumbnail page arranged in the opposite direction may be the last page.

In response to a capacity of the storage being exceeded, the controller may delete image information related to at least one thumbnail page of all the thumbnail pages, except for the currently-displayed thumbnail page and a thumbnail page to be generated in advance, from among pre-stored image information related to the thumbnail pages.

In this case, the image information relating to the thumbnail page may be at least one of uncompressed bitmap information and compressed bitmap information which corresponds to a thumbnail image which constructs the thumbnail page.

An original copy of the thumbnail image may be at least one of a still image and a video (moving image).

In response to the original thumbnail image being a video, the thumbnail image may be an animation image constructed by including a plurality of still images.

The controller may sequentially generate thumbnail images which are configured to be a thumbnail page, which is to be displayed according to the thumbnail page turn command, in a row unit or in a column unit.

The display apparatus may further include a communicator configured to execute communication with an external device. The controller may generate image information relating to the thumbnail page by sequentially receiving at least part of image data, which is required to generate the image information relating to the thumbnail page, from among original image data stored in the external device.

A method of controlling a display apparatus in accordance with one exemplary embodiment may include displaying a thumbnail page having at least one thumbnail image, generating and storing in advance image information which relates to at least one thumbnail page arranged in a page turning direction and at last one thumbnail page arranged in an opposite direction to the page turning direction, based on a currently-displayed thumbnail page, and generating and displaying a thumbnail page to be displayed according to a thumbnail page turn command based on the stored image information.

The method may further include storing image information relating to the currently-displayed thumbnail page.

The generating and storing of the image information in advance may be executed to generate and store the image information_related to the thumbnail pages such that the number of thumbnail pages arranged in the page turning direction is greater than the number of thumbnail pages arranged in the opposite direction.

In response to the currently-displayed thumbnail page being the last page, the at least one thumbnail page arranged in the page turning direction may be a start page. In response to the currently-displayed thumbnail page being the start page, the at least one thumbnail page arranged in the opposite direction may be the last page.

The method may further include deleting image information related to at least one thumbnail page from among all of the thumbnail pages, except for the currently-displayed thumbnail page and a thumbnail page to be generated in advance, from among image information related to the pre-stored thumbnail pages in response to a capacity of the storage being exceeded.

In this case, the image information relating to the thumbnail page may be at least one of uncompressed bitmap information and compressed bitmap information which corresponds to a thumbnail image constructing the thumbnail page.

An original copy for the thumbnail image may be at least one of a still image and a video (moving image).

In response to the original thumbnail image being a video, the thumbnail image may be an animation image constructed by including a plurality of still images.

The generating and storing of the image information relating to the thumbnail page in advance may be executed to sequentially generate thumbnail images configuring a thumbnail page, which is to be displayed according to the thumbnail page turn command, in a row unit or in a column unit.

The generating and storing of the image information relating to the thumbnail page in advance may be executed to generate image information relating to the thumbnail page by sequentially receiving, through communication with an external device, at least part of the image data, which is required to generate the image information relating to the thumbnail page, from among original image data stored in the external device.

An aspect of an exemplary embodiment may provide a display apparatus including: a user interface configured to receive a thumbnail page turn command; and a controller configured to generate and store in advance image information relating to at least one thumbnail page arranged in a page turning direction and at last one thumbnail page arranged in an opposite direction to the page turning direction, and generate a thumbnail page to be displayed according to the thumbnail page turn command.

The display apparatus may further include a display configured to display a thumbnail page including at last one thumbnail image and a storage.

The image information stored in advance may be based on a currently-displayed thumbnail page. The thumbnail page to be displayed according to the thumbnail page turn command may be based on the image information stored in the storage.

In addition, the controller may be further configured to store image information relating to the currently-displayed page in the storage. The controller may be configured to store and generate the image information related to the thumbnail pages such that the number of thumbnail pages arranged in the page turning direction is greater than the number of thumbnail pages arranged in the opposite direction.

As described above, according to the exemplary embodiments, since a thumbnail page can be provided fast, user convenience may be improved.

### BRIEF DESCRIPTION OF THE DRAWINGS

The above and/or other aspects will be more apparent by describing certain exemplary embodiments with reference to the accompanying drawings, in which:

FIG. 1 is a view of a display system in accordance with an exemplary embodiment.

FIGS. 2(a) and 2(b) are a block diagrams which illustrate a configuration of a display apparatus in accordance with an exemplary embodiment.

FIG. 3 is a view which illustrates a software configuration stored in a storage.

FIG. 4 is a view which illustrates a method of storing thumbnail image information in accordance with an exemplary embodiment.

FIGS. 5a and 5b each represent a view which illustrates a method of displaying a thumbnail image in accordance with an exemplary embodiment.

FIGS. 6a and 6b each represent a view which illustrates a method of displaying a thumbnail image in accordance with an exemplary embodiment.

FIG. 7 is a flowchart which illustrates a method of controlling a display apparatus in accordance with an exemplary embodiment.

FIG. 8 is a flowchart which illustrates a method of controlling a display apparatus in accordance with another exemplary embodiment.

FIG. 9 is a detailed flowchart which illustrates a step of generating a list of predicted (expected) thumbnails, as shown in FIG. 8.

FIG. 10 is a detailed flowchart which illustrates a step of updating a thumbnail cache, as shown in FIG. 8.

### DETAILED DESCRIPTION OF THE EXEMPLARY EMBODIMENTS

Hereinafter, description will be given in detail of the present disclosure with reference to the accompanying drawings.

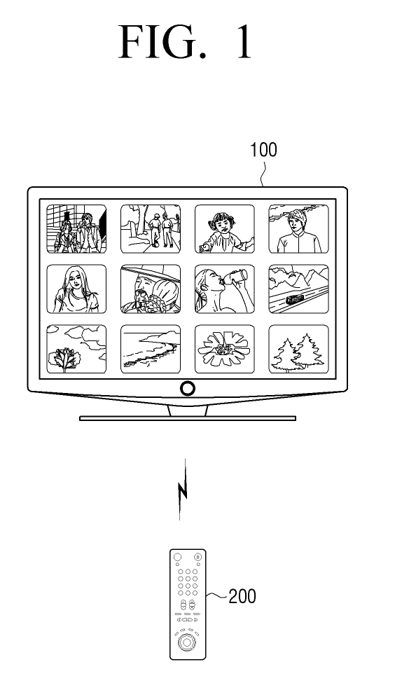

FIG. 1 is a view of a display system in accordance with an exemplary embodiment.

As illustrated in FIG. 1, a display system according to an exemplary embodiment may include a display apparatus 100 and a remote controller 200.

The display apparatus 100 may be implemented as, but is not limited to, a digital TV as illustrated in FIG. 1. The display apparatus 100 may be implemented as various types of apparatuses having a display function, such as a PC, a mobile phone, a tablet PC, a PMP, a PDA, a navigator, and the like. When the display apparatus 100 is implemented as a portable device, it may have a touch screen mounted therein so as to execute a program by using a finger or a pen (for example, a stylus pen). Hereinafter, description will be made for the sake of explanation of an example where the display apparatus is implemented as a digital TV.

The display apparatus 100 as illustrated may display a user interface (UI) screen including thumbnail images.

Specifically, the display apparatus 100 may provide a thumbnail browser UI for searching for image data in a unit of a thumbnail page, which includes at least one thumbnail image. Here, an original image data may be, but is not limited to, remote files, and the like, obtained through a USB external device and an Ethernet network.

In response to the display apparatus 100 being the digital TV, it may be controlled by the remote controller 200. The remote controller 200 may be a device for remotely controlling the display apparatus 100. The remote controller 200 may receive a user command and may transmit to the display apparatus 100 a control signal which corresponds to the received user command. For example, the remote controller 200 may be implemented into various forms, such as sensing movement of the remote controller 200 and transmitting a signal which corresponds to the movement, recognizing a voice and transmitting a signal which corresponds to the recognized voice, or transmitting a signal which corresponds to an input key.

The display apparatus 100 may turn over and display a thumbnail page according to a page turn command or page switching (changing, moving, or shifting command) input through the remote controller 200.

Hereinafter, description will be made of a method of displaying a thumbnail page in accordance with an exemplary embodiment with reference to a block diagram which illustrates a detailed configuration of the display apparatus 100.

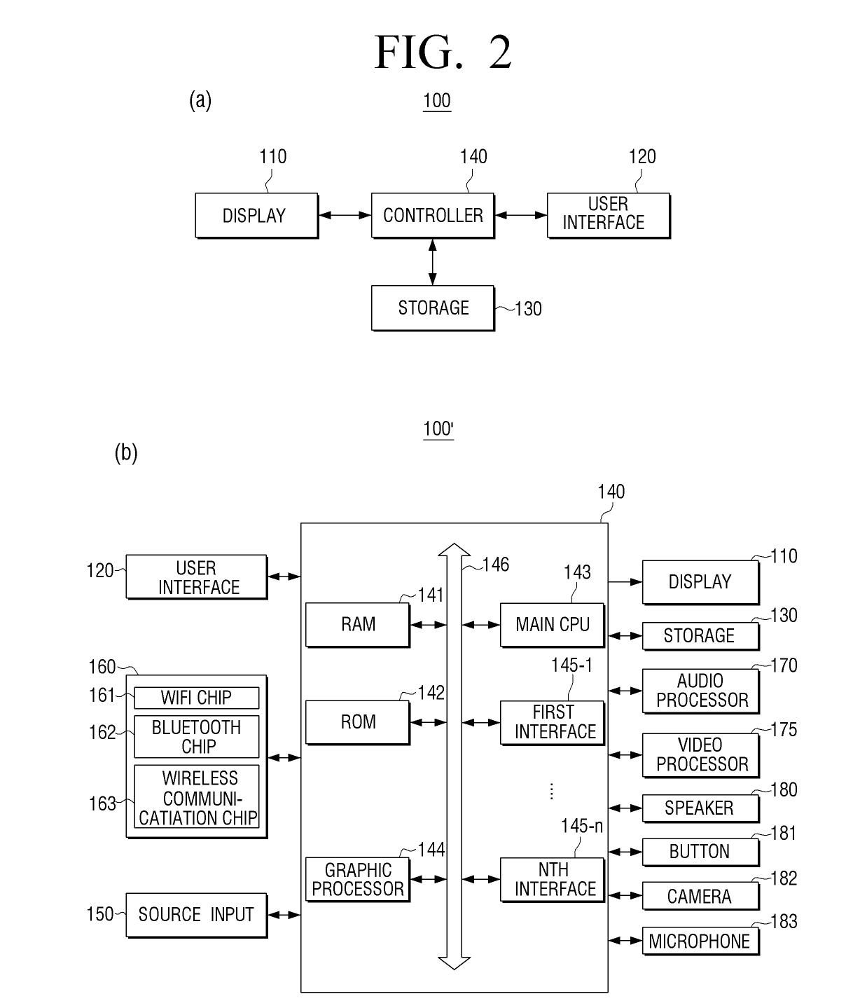

FIG. 2 is a block diagram which illustrates a configuration of a display apparatus in accordance with an exemplary embodiment.

As illustrated in FIG. 2A, the display apparatus 100 may include a display 110, a user interface 120, a storage 130 and a controller 140.

The display 110 may display a screen. Here, the screen may include a screen for reproducing (playback) of various types of contents, such as image, video, text, music and the like, a screen for executing an application including various contents, a web browser screen, a graphic user interface (GUI) screen, and the like.

The display 110 may display a thumbnail browser UI screen for searching for image data in a unit of a thumbnail page in accordance with one exemplary embodiment, based on a preset event. The preset event may include various events, which allow for outputting thumbnail images, such as an execution of an image view application.

Each thumbnail page may be displayed in a preset layout. For example, as illustrated in FIG. 1, one thumbnail page may output a total of 12 thumbnail images in a 4×3 layout, but the exemplary embodiments may not be limited to this.

The display 110 may be implemented as, but not limited to, a liquid crystal display (LCD) panel, an organic light emitting diode (OLED), and the like.

The user interface 120 may receive a user command.

Specifically, the user interface 120 may receive a thumbnail page turn command for turning a displayed thumbnail page over another thumbnail page.

The user interface 120 may be implemented in various forms according to the implementation of the display apparatus 100. For example, when the display apparatus 100 is implemented as a digital TV, the user interface 120 may be implemented as a remote receiver which receives a remote signal from the remote controller 200. In response to the display apparatus 100 being implemented as a smart phone, the user interface 120 may be configured as a touch screen having a layered structure with a touchpad. In this case, the user interface 120 may be used as the display 110.

The storage 130 may store an O/S software module configured to drive the display apparatus 100, various applications, and various data such as various contents which are input or set during an execution of applications.

In particular, the storage 130 may store image information relating to at least one thumbnail page according to the control of the controller 140, which will be understood through description for the controller 140.

The controller 140 may execute an overall control of the display apparatus 100.

The controller 140 may generate image information relating to a previous or next thumbnail page based on a currently-displayed thumbnail page and may store the generated image information in the storage 130. The thumbnail page related image information may include at least one of uncompressed bitmap information and compressed bitmap information, which corresponds to a thumbnail image configuring a thumbnail page.

In particular, the controller 140 may generate, in advance, image information relating to at least one thumbnail page arranged in a page turning direction and image information relating to at least one thumbnail page arranged in an opposite direction, according to a thumbnail page turn command, and may then store the generated image information in the storage 130. For example, in response to a currently-displayed page being a second page and the page turning direction being a right-hand side, the controller 140 may generate, in advance, bitmap information relating to thumbnails, included in a third page arranged in a right-hand side and a first page arranged in a left-hand side, and may store the generated bitmap information.

Here, the thumbnail pages may be arranged in a left/right direction or an up/down direction. Accordingly, the page turning direction may also be the left/right direction or the up/down direction. In particular, a page turn command may be input in response to a left/right (or up/down) manipulation of navigation keys disposed on the remote controller 200, left/right (or up/down) flicking or dragging on a touch panel disposed on the remote controller 200, left/right (or up/down) scrolling of a scroll key disposed on the remote controller 200, and the like. However, the exemplary embodiments may not be limited to this. The page turnover (page changing, page shifting) may be achieved by a motion of a user or the remote controller 200, voice input, and the like. In response to the display apparatus 100 being implemented as a portable device having a touch screen, the page turnover may be achieved by left/right (or up/down) flicking, dragging, scrolling or the like with respect to the touch screen using a finger or a pen.

The controller 140 may determine the page turning direction based on at least one of a key manipulation history and a page display history.

In particular, the controller 140 may determine that the page turning direction is a right-hand side when a right navigation key has been manipulated. Or, the controller 140 may determine that a direction that a third page is displayed is the page turning direction when a first page and a second page have previously been displayed in a sequential manner.

Also, the controller 140 may generate and store thumbnail pages according to preset priorities. The priority may depend on the page turning direction. For example, a thumbnail page arranged in the page turning direction may have the highest priority.

In particular, the controller 140 may first generate bitmap information related to a thumbnail page which has the highest priority and is currently displayed, generate bitmap information related to at least one thumbnail page which has the next highest priority and is arranged in the page turning direction, and generate bitmap information related to at least one thumbnail page which has the next higher priority and is arranged in an opposite direction to the page turning direction. The controller 140 may then store the generated bitmap information.

In response to original image data being transmitted from another device through a network (for example, a digital living network alliance (DLNA) network), the controller 140 may sequentially receive at least part of the image data required to generate image information related to a thumbnail page, which is to be displayed next according to the page turning direction, from among original image data stored in the another device, thereby generating the image information related to the thumbnail page. That is, in response to an original image being stored in the another device, the controller 140 may generate the thumbnail page by sequentially receiving only image data to be displayed next without receiving all of the corresponding image data. Here, the image data may be sequentially received in a thumbnail page unit or a column or row unit of the thumbnail page.

The controller 140 may also display thumbnail pages in a queuing or sliding manner. Here, the queuing manner refers to a method of displaying a previous thumbnail page and the next thumbnail page, independent of each other, and the sliding manner refers to a method of displaying the next thumbnail page seamlessly after the previously displayed thumbnail page.

The controller 140 may generate and store bitmap information related to thumbnail pages in a column or row unit upon generating the bitmap information for the thumbnail pages. In response to the thumbnail pages having a 4×3 layout, the controller 140 may first generate bitmap information related to three thumbnail images of a first column, and sequentially may generate bitmap information related to three thumbnail images of a second column. Accordingly, upon being displayed in a left/right sliding manner, such seamless displaying may be achieved. In particular, the controller 140 may generate bitmap information in sequence of (1, 1), (1, 2), (1, 3), (2, 1), (2, 2), (2, 3) and the like, or in sequence of (1, 1), (1, 2), (1, 3), (2, 3), (2, 2), (2, 1) and the like. Here, upon being displayed in an up/down sliding manner, the controller 140 may first generate bitmap information related to four thumbnail images of a first row and may sequentially generate bitmap information related to four thumbnail images of a second row.

In response to a displayed thumbnail page being the last page, at least one thumbnail page arranged in a page turning direction may be a start page. When the currently-displayed thumbnail page is the start page, at least one thumbnail page arranged in an opposite direction to the page turning direction may be the last page.

The controller 140 may also store image information related to thumbnail pages such that the number of the thumbnail pages arranged in the page turning direction is different from the number of thumbnail pages arranged in the opposite direction. For example, the controller 140 may generate and store image information related to thumbnail pages such that the number of thumbnail pages arranged in the page turning direction is greater than the number of thumbnail pages arranged in the opposite direction.

With regard to storing image information related to a new thumbnail page, in response to a capacity of the storage being exceeded, the controller 140 may delete image information related to at least one thumbnail page from among all of the thumbnail pages, except for a currently-displayed thumbnail page and a thumbnail page to be generated in advance, from among image information related to pre-stored thumbnail pages.

In response to a page turnover being done fast, the controller 140 may stop the generation of preceding and succeeding thumbnail pages of a thumbnail image displayed therebetween, and may generate only a thumbnail page which corresponds to the page turnover stop time point of the page turnover. Accordingly, a thumbnail image displayed in response to the fast page turnover may be provided as a default image. For example, in response to a thumbnail image being a photo, a default image including an icon representing a camera may be displayed.

In response to the thumbnail page being fast turned over fast, the controller 140 may not generate image information related to preceding and succeeding thumbnail pages arranged based on a thumbnail page displayed therebetween, but may generate and store image information related to preceding and succeeding thumbnail pages arranged based on a thumbnail page, which is displayed at a page turnover stop point of time. For example, in response to the thumbnail pages from page 1 to page 4 being turned over fast in the up/down scrolling manner, thumbnail images for page 2 and page 3, which are displayed during the turning, may not be generated, a thumbnail image for page 4, which is displayed at the time point of the turning being stopped, may be displayed, and only thumbnail images for page 2 and page 5, which are arranged before and after the thumbnail page for page 4, may be generated.

The controller 140 may decode additional information obtained from a received original image data and may convert the additional information into a thumbnail size, or decode the original image data in response to additional information not being present and may convert the decoded original image data into a thumbnail size, thereby extracting a thumbnail image in the reduced size to be stored in the storage 130. The original image data may be at least one of a still image and a video.

In response to the original image data being a video, the controller 140 may generate a thumbnail image in a form of an animation image configured by including a plurality of still images.

Accordingly, the controller 140 may generate a thumbnail page to be displayed according to a thumbnail page turn command, based on the stored image information.

As described above, the display apparatus 100 according to the an exemplary embodiment may obtain in advance thumbnail information to be displayed next while a thumbnail page is displayed, and may store the obtained thumbnail information in the storage 130, for example, in a cache. That is, while a current page viewed by a user is displayed on the display apparatus 100, a user may read in advance thumbnail information to be displayed next, decode the thumbnail information, adjust a size of the thumbnail information and store the size-adjusted thumbnail information in the cache. In other words, operations of reading data from an external storage medium (not shown), decoding the data, and displaying the data on a screen may be divided into threads, in parallel, so as to be simultaneously processed. In general, since image decoding requires a long period of time, such decoding may be divided into several threads in a system having a multi-core CPU such that the several threads can be executed at the same time.

Accordingly, while shifting pages according to a user command, thumbnail information which has been obtained in advance may be read out of a cache to be displayed immediately, without carrying out processes such as reading from an external storage medium, decoding, and the like.

In the meantime, image information stored in the storage 130 may be, for example, one of bitmap information and compressed bitmap information. For the compressed bitmap information, a cache capacity may be effectively used. Also, the data may be read beforehand from a local memory such as DDR and decoded when being displayed on a screen so as to be processed fast, rather than data being read from an external device such as Ethernet and USB, and then decoded.

For example, for a JPEG image, in response to compressed thumbnail data being already present within a JPEG EXIF, the compressed data may be stored in a cache as it is (First exemplary embodiment), and if not, bitmap data which has been decoded and reduced in size may be stored in the cache (Second exemplary embodiment). In response to a thumbnail of the corresponding JPEG being displayed on a screen, in the first exemplary embodiment, the compressed data stored in the thumbnail cache may be read, decoded and changed in size, so as to be displayed on the screen after graphic rendering. Data obtained by decoding may not be stored in the cache. In a second exemplary embodiment, bitmap data stored in the thumbnail cache may be read and then displayed after graphic rendering.

FIG. 2B is a block diagram which illustrates a configuration of a display apparatus 100′ in accordance with another exemplary embodiment. As illustrated in FIG. 2B, the display apparatus 100′ may include a display 110, a user interface 120, a storage 130, a controller 140, a source input 150, a communicator 160, an audio processor 170, a video processor 175, a speaker 180, a button 181, a camera 182 and a microphone 183. Detailed description of the same/like components illustrated in FIG. 2 to those components illustrated in FIG. 1 will not be repeated.

The source input 150 may receive original image data for a thumbnail image. The source input 150 may be implemented into a USB port or a communication module allowing network communication. In response to the source input 150 being implemented into the communication module, it may be implemented as the form of the communicator 160 which will be explained below.

In particular, the source input 150 may receive original image data from an external device, such as a storage medium connected via the USB port, or may receive original image data from an external device, such as a server connected via the network communication.

The controller 140 may extract a thumbnail image from the original image data received via the source input 150.

For example, for a JPEG photo existing in a storage medium connected via a USB, the controller 140 may acquire a thumbnail bitmap by decoding additional information within EXIF existing in a file. In response to such additional information not existing, the controller 140 may acquire a predetermined size of thumbnail bitmap by decoding the very JPEG photo. Or, when a JPEG photo is existing in a digital living network alliance (DLAN) server, the controller 140 may receive image information for a thumbnail image, such as JPEG_TN, PNG_TN and the like, which are regulated in the SPEC, through the Ethernet.

The communicator 160 may execute communication with an external device according to various types of communication methods.

The communicator 160 may serve to receive various types of original image data or thumbnail images (or thumbnail image information) from an external device. The communicator 160 may include various communication chips, such as a WiFi chip 161, a Bluetooth® chip 162, a wireless communication chip 163 and the like. The WiFi chip 161 and the Bluetooth® chip 162 may execute communication according to WiFi and Bluetooth® communication standards, respectively. The wireless communication chip 163 refers to a chip which executes communication according to various communication standards, such as IEEE®, Zigbee®, Third Generation (3G), Third Generation Partnership Project (3GPP), Long Term Evolution (LTE)® and the like. In addition, the communicator 160 may further include a Near Field Communication (NFC) chip which operates according to an NFC communication standard, which uses 13.56 MHz among different RF-ID frequency bands, such as 135 kHz, 13.56 MHz, 433 MHz, 860˜960 MHz, 2.45 GHz, and the like.

The audio processor 170 may be a component for processing audio data. The audio processor 170 may execute various types of image processing, such as decoding, amplifying, noise filtering, and the like, for audio data.

The video processor 175 may be a component for processing video data. The video processor 175 may execute various types of image processing, such as decoding, scaling, noise filtering, frame rate conversion, resolution conversion, and the like, for video data.

The speaker 180 may be a component for outputting various notification sounds and voice messages as well as various types of audio data processed by the audio processor 170.

The button 181 may be various types of buttons, such as mechanical buttons, a touch pad, a wheel and the like, which are formed on a random area of a front, side or rear surface of an appearance of a main body of the display apparatus 100′. For example, a button for powering the display apparatus 100′ on or off may be provided.

The camera 182 may capture a still image or a video according to a user's control. The camera 182 may be implemented in plurality to include a front camera and a rear camera.

The microphone 183 may convert a user's voice or other sounds received into audio data. The controller 140 may use the user's voice received via the microphone during a call process or may convert the user's voice into audio data to store in the storage 130.

In response to the camera 182 and the microphone 183 being provided, the controller 140 may perform a control operation according to the user's voice input via the microphone 183 or a user's motion recognized by the camera 182. That is, the display apparatus 100′ may operate in a motion control mode or a voice control mode. In motion control mode, the controller 140 may capture a user's image by activating the camera 182 and track down changes in the user's motion in order to carry out a control operation. In the voice control mode, the controller 140 may operate in a voice recognition mode, in which the controller 140 analyzes a user's voice input via the microphone 183 and carries out a control operation according to the analyzed user's voice.

In addition, the display apparatus 100′ may further include various external input ports for connection with various external terminals, such as a headset, a mouse, a LAN, and the like.

The controller 140 may control an overall operation of the display apparatus 100′ using various types of programs stored in the storage 130.

For example, the controller 140 may execute an application stored in the storage 130 in order to output an execution screen for the application, for example, a thumbnail browser screen. Or, the controller 140 may playback various contents stored in the storage 130. The controller 140 may also execute communication with external devices via the communicator 160.

In particular, the controller 140 may include a RAM 141, a ROM 142, a main CPU 143, a graphic processor 144, first to n^{th} interfaces 145-1 to 145-n, and a bus 146.

The RAM 141, the ROM 142, the main CPU 143, the graphic processor 144, and the first to n^{th} interfaces 145-1 to 145-n may be interconnected via the bus 146.

The first to n^{th} interfaces 145-1 to 145-n may be connected to those components. One of the interfaces may be a network interface which is connected to an external device via a network.

The main CPU 143 may access the storage 130 to execute booting using an operating system (O/S) stored in the storage 130. Also, the main CPU 143 may execute various operations using various programs, contents, data and the like stored in the storage 130.

The ROM 142 may store command word sets for system booting. When power is supplied in response to an input of a turn-on command, the main CPU 143 may copy the O/S stored in the storage 130 into the RAM 141 according to a command word stored in the ROM 142 and boot a system by executing the O/S. In response to the booting being completed, the main CPU 143 may copy various application programs stored in the storage 130 into the RAM 141 and execute the application programs copied into the RAM 141 in order to execute various operations.

The graphic processor 144 may generate a screen including various objects, such as icon, image, text, and the like, using a calculating element (not shown) and a rendering element (not shown). The calculating element (not shown) may calculate attribute values, such as coordinate values, shape, size, color and the like for displaying each object according to a layout of the screen based on a received control command. The rendering element (not shown) may generate a screen of various layouts including objects based on the attribute values calculated by the calculating element (not shown). The screen generated by the rendering element (not shown) may be output within a display area of the display 110.

The aforementioned operations of the controller 140 may be carried out by programs stored in storage 130. The storage 130 may include an O/S software module for driving the display apparatus 100′, various applications, and various data such as various contents which are input or set during execution of the applications.

In particular, the storage 130 may store other users' profile information, which are input by a user or received from an exterior device.

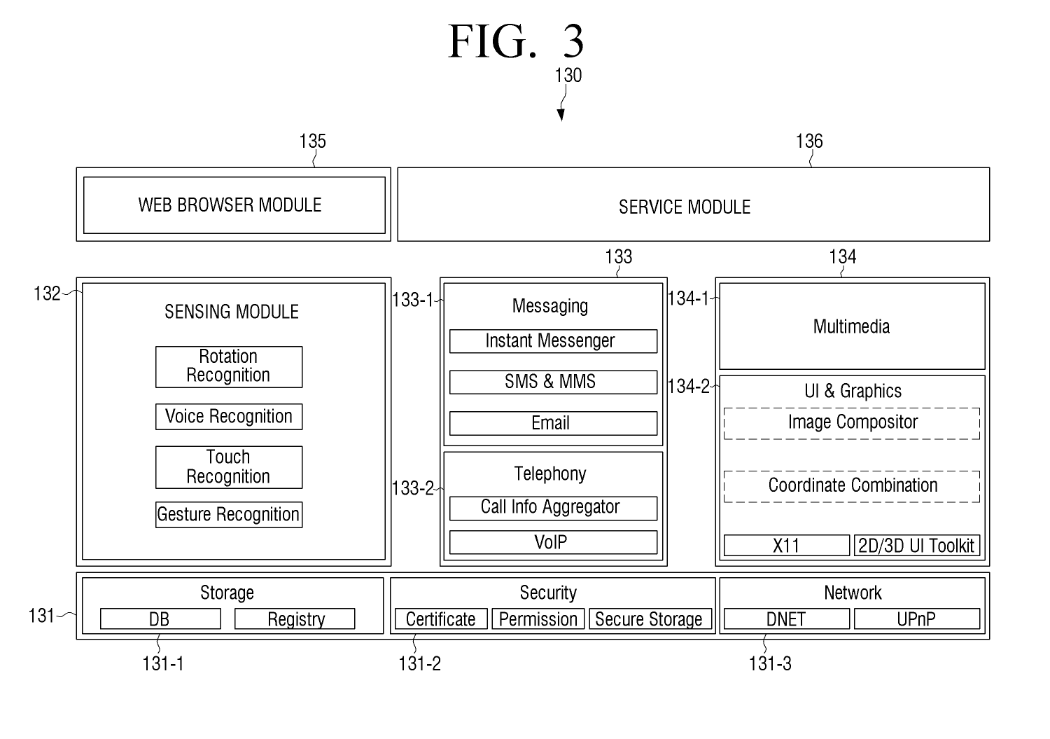

Other various software modules stored in the storage 130 will be explained below with reference to FIG. 3.

Although not shown, the display apparatus 100′ may further include a feedback element (not shown). The feedback element may provide various feedbacks according to a function executed on the display apparatus 100.′ For example, the feedback element may provide an audio feedback upon shifting a thumbnail page according to a thumbnail page turn command.

FIG. 2B exemplarily illustrates the detailed configuration of the display apparatus 100′. Depending on the exemplary embodiment, some of those components illustrated in FIG. 2B may be omitted or changed, or other components may be further provided. For example, in response to the display apparatus 100 being implemented as a mobile phone, the display apparatus 100′ may further include a global positioning system (GPS) receiver (not shown) to receive a GPS signal from a GPS satellite and to calculate a current position of the apparatus 100′, a digital multimedia broadcasting (DMB) receiver (not shown) to receive and process a DMB signal, and the like.

FIG. 3 is a view which illustrates a software configuration stored in the storage 130.

As illustrated in FIG. 3, the storage 130 may store software including a base module 131, a sensing module 132, a communication module 133, a presentation module 134, a web browser module 135 and a service module 136.

The base module 131 refers to a basic module which processes a signal transferred from respective hardware included in the display apparatus 100 to transfer to an upper layer module. The base module 131 may include a storage module 131-1, a security module 131-2, a network module 131-3, and the like. The storage module 131-1 may be a program module which manages a database (DB) or a registry. The main CPU 143 may access a database within the storage 130 using the storage module 131-1, in order to read various data. The security module 131-2 may be a program module which supports certification, permission, secure storage, and the like, for hardware. The network module 131-3 may be a module for supporting network connection, and may include a DNET module, an UPnP module, and the like.

The sensing module 132 may be a module which collects information from various sensors and analyzes and manages the collected information. The sensing module 132 may include a face recognition module, a voice recognition module, a motion or touch recognition module, an NFC recognition module, a rotation recognition module, and the like.

The communication module 133 may be a module which performs communication with an exterior device. The communication module 133 may include a messaging module 133-1 such as a messenger program, a short message service (SMS) & multimedia message service (MMS) program, an email program and the like, and a phone module 133-2 which includes a call Info aggregator program module, a VoIP module, and the like.

The presentation module 134 may be a module for configuring a display screen. The presentation module 134 may include a multimedia module 134-1 which reproduces and outputs multimedia contents, and a UI rendering module 134-2 which executes graphic processing. The multimedia module 134-1 may include a player module, a camcorder module, a sound processing module and the like. Accordingly, the presentation module 134 may carry out an operation of reproducing various multimedia contents so as to generate and playback a screen and sound. The UI rendering module 134-2 may include an image compositor module which combines images, a coordinate combination module which combines and generates coordinates on a screen to display an image, an X11 module which receives various events from hardware, a 2D/3D UI toolkit which provides tools for configuring a UI in a 2D or 3D form.

The web browser module 135 refers to a module which accesses a web server through web browsing. The web browser module 135 may include various modules, such as a web view module for configuring a web page, a download agent module for executing downloading, a bookmark module, a webkit module, and the like.

The service module 136 may be a module which includes various applications for providing various services. In particular, the service module 136 may include various program modules, such as a navigation program, a contents playback program, a game program, an e-book program, a calendar program, an alarm management program, other widgets, and the like. Specifically, the service module 136 may include a program module which provides a phonebook service according to an exemplary embodiment.

FIG. 3 illustrates various program modules, but the illustrated program modules may also be partially omitted, varied or added according to the type and features of the display apparatus 100. For example, the program modules may be implemented in a form further including a position-based module which supports a position-based service in cooperation with hardware such as a GPS chip.

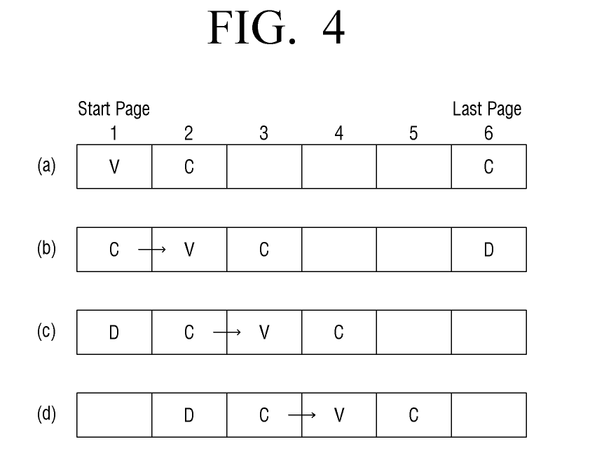

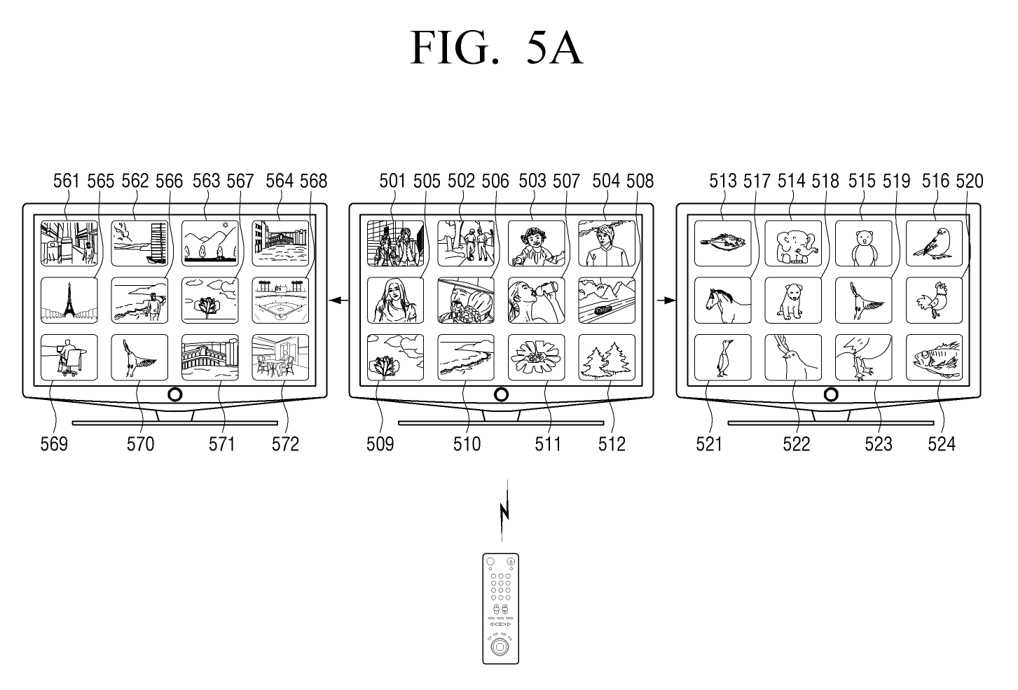

FIG. 4 is a view which illustrates a method of storing thumbnail image information in accordance with an exemplary embodiment.

For the sake of explanation, FIG. 4 exemplarily illustrates that a total of 6 thumbnail pages are provided to configure a thumbnail browser screen, and a cache has a capacity large enough to store thumbnail bitmaps which correspond to a total of three pages. In FIG. 4, a thumbnail page which a user desires to view, namely, a currently-displayed thumbnail page is represented with “V” (view page), a thumbnail page which is not currently displayed but has been displayed before or has been stored with its thumbnail image information extracted in advance is represented with “C” (cached page), and a page which was stored in a cache area but has been deleted is represented with “D” (deleted page).

In general, thumbnail pages are arranged in a sequence which is preset by a user. Accordingly, a thumbnail page 1 becomes a default page which is automatically selected upon first entrance into a thumbnail browser.

Assuming that each thumbnail page is configured by including 12 thumbnails, the controller 140 may extract 12 thumbnail bitmaps in order to display the thumbnail page 1, and may then store the extracted data in the storage 130, for example, in a cache.

As illustrated in FIG. 4A, while the thumbnail page 1 is displayed according to a user selection, namely, in parallel to an operation of rendering and displaying the thumbnail page 1 on a screen, the controller 140 may receive original image data for a page 2 and a page 6 to which a page is expected to be shifted in the next stage (step), decode the received original image data in advance and store the corresponding thumbnail image information in the cache. Page 2 may be a page which is to be displayed in response to the user turning a page from the page 1 to a right-hand side (or in a succeeding direction) and the page 6 may be a page which is to be displayed when the user turns a page from the page 1 to a left-hand side (or in a preceding direction). That is, the page 6 may be required by a wrap-around operation when the user turns the page from the page 1 to the left-hand side.

As illustrated in FIG. 4B, in response to the page 2 being displayed in the next step according to the user selection, the controller 140 may fast acquire the thumbnail bitmap of the page 2 from cache information which has been generated and stored in the previous stage.

In response to page 2 being displayed, the controller 140 may maintain the thumbnail bitmap information related to the page 1 as is because it is data stored in the previous stage and may newly extract and store thumbnail bitmap data related to the page 3, of the thumbnail bitmap information related to the page 3 and the page 1, for which a user selection is expected. In this case, since the cache has the capacity which corresponds to three pages, the data of page 3 may be stored after deleting information related to page 6.

As illustrated in FIG. 4C, in response to page 3 being displayed in the succeeding step according to the user selection, the controller 140 may fast acquire the thumbnail bitmap of the page 3 from the cache information generated and stored in the previous stage.

The controller 140 may newly extract thumbnail bitmap data of a page 4 of the pages 2 to 4, for which the user selection is expected in the next stage, and may store the extracted data after deleting the information related to the page 1.

As illustrated in FIG. 4D, in response to the page 4 being displayed in the next stage according to the user selection, the controller 140 may fast acquire the thumbnail bitmap of the page 4 from the cache information generated and stored in the previous stage. In addition, the controller 140 may newly extract thumbnail bitmap data of a page 5 for which the user selection is expected in the next stage and may store the newly extracted data after deleting the information related to page 2.

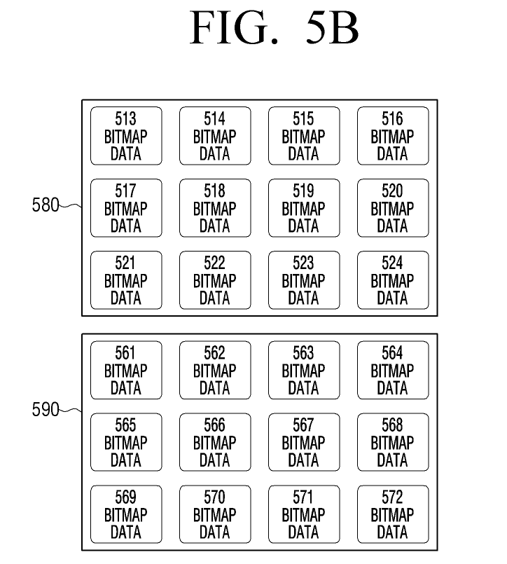

FIG. 5 is a view which illustrates a method of displaying a thumbnail image in accordance with an exemplary embodiment.

As illustrated in FIG. 5A, description will be given of an exemplary embodiment, in which a total of 6 thumbnail pages configure a thumbnail browser screen in a digital TV and each thumbnail page includes 12 thumbnail images in a 4×3 layout, namely, totally 72 thumbnail images are provided on the thumbnail browser screen.

As illustrated in FIG. 5A at an upper right-hand side, a first thumbnail page including 12 thumbnail images 501 to 512 from among the totally 72 thumbnail images may be displayed. Here, the 72 thumbnail images may be displayed in a sequence preset by a user (for example, a sequence recorded in a USB storage medium) and thumbnail images configuring each thumbnail page may be pre-decided based on the preset sequence. However, this is merely illustrative. According to another exemplary embodiment, the displaying sequence of the 72 thumbnail images may be automatically set based on their order of generation.

Referring to FIG. 5B, image information 580 related to thumbnail images 513 to 524, which configure the second thumbnail page arranged after the first thumbnail page, and image information 590 related to thumbnail images 561 to 572, which configure the last thumbnail page arranged before the first thumbnail page, namely, a sixth thumbnail page, may be generated in advance and stored. Here, the image information may have a format of bitmap data, as illustrated. The bitmap data may have a compressed or uncompressed format.

Referring back to FIG. 5A, in response to a thumbnail page turn command being input through the remote controller 200, the display apparatus 100 may display a thumbnail page arranged in a thumbnail turn direction which corresponds to the thumbnail page turn command.

For example, as illustrated in FIG. 5A at an upper right-hand side, a second thumbnail page may be displayed according to a thumbnail page turn command toward a right-hand side. Here, the second thumbnail page may be generated based on the pre-stored image information 580 related to the thumbnail images 513 to 524, as illustrated in FIG. 5B.

As illustrated in FIG. 5A at a lower left-side, the last thumbnail page, namely, the sixth thumbnail page may be displayed according to the thumbnail page turn command toward a left-hand side. Here, the sixth thumbnail page may be generated based on the pre-stored image information 590 related to the thumbnail images 561 to 572, illustrated in FIG. 5B.

These processes may allow for a fast thumbnail page generation, according to the thumbnail page turning.

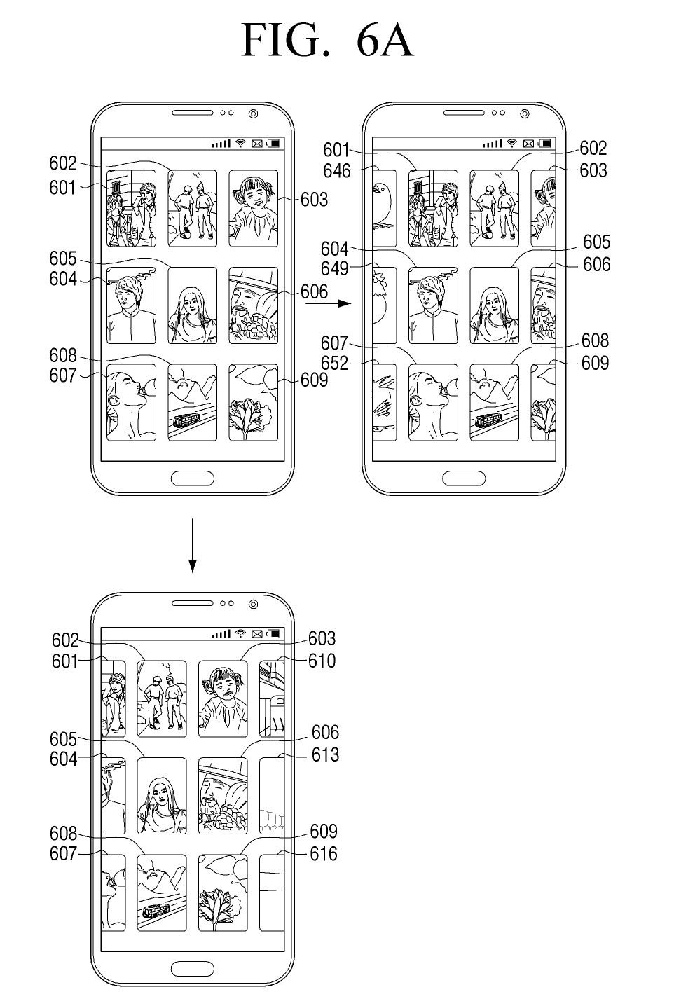

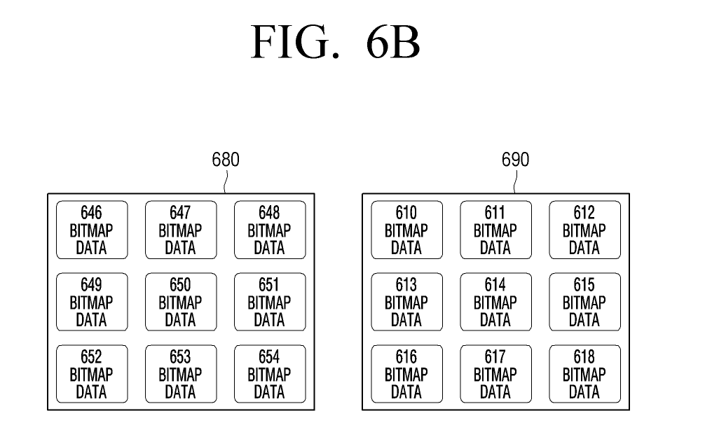

FIG. 6 is a view which illustrates a method of displaying a thumbnail image in accordance with an exemplary embodiment.

As illustrated in FIG. 6A, description will be given of an exemplary embodiment, in which a total of 6 thumbnail pages configure a thumbnail browser screen in a smart phone and each thumbnail page includes 9 thumbnail images in a 3×3 layout, namely, totally 54 thumbnail images are provided on the thumbnail browser screen.

As illustrated in FIG. 6A at an upper left-hand side, a first thumbnail page including first 9 thumbnail images 601 to 609 from among the total of 54 thumbnail images may be displayed. Here, the totally 54 thumbnail images may be arranged in a preset sequence, as aforementioned with respect to FIG. 5A.

Referring to FIG. 6B, image information 680 related to thumbnail images 646 to 654, which configure the sixth thumbnail page arranged before the first thumbnail page, and image information 690 related to thumbnail images 610 to 618, which configure the second thumbnail page arranged after the first thumbnail page, may be generated in advance and stored. In some cases, only image information related to thumbnail images 648, 651 and 654, which are located in the rightmost row displayed first according to a sliding type page turning, among the thumbnail images 646 to 654 configuring the sixth thumbnail page, may be generated in advance. That is, the image information generated in advance may be generated in a column or row unit configuring a thumbnail page, other than as a unit of a thumbnail page.

Referring back to FIG. 6A, in response to a thumbnail page turn command being input via the remote controller 200, the display apparatus 100 may display a thumbnail page arranged in a thumbnail turning direction which corresponds to the thumbnail page turn command. Here, the page turn command may be input by a user's manipulation in a manner of right or left flicking or dragging on a touch screen.

For example, as illustrated in FIG. 6A at an upper right-hand side, a partial area of a first page and a partial area of a second page may be displayed on one screen according to a thumbnail page turn command toward a right-hand side. Here, newly displayed thumbnail images 646, 649 and 652 may be generated based on the pre-stored image information 680 related to the thumbnail images 646 to 654, illustrated in FIG. 6B.

Also, as illustrated in FIG. 6A at a lower left-hand side, a partial area of a first page and a partial area of a second page may be seamlessly displayed on one screen according to a thumbnail page turn command toward a left-hand side. Here, newly displayed thumbnail images 610, 613 and 616 may be generated based on the image information 680 related to the thumbnail images 646 to 654, illustrated in FIG. 6B. Or, in some cases, only image information related to thumbnail images 610, 613 and 616, which are located in the rightmost row displayed first according to a sliding type page turning, from among the thumbnail images 610 to 618 configuring the second thumbnail page, may be generated in advance. That is, the image information generated in advance may be generated in a column or row unit configuring a thumbnail page, rather than a unit of a thumbnail page.

These processes may allow for a fast thumbnail page generation according to the thumbnail page shifting.

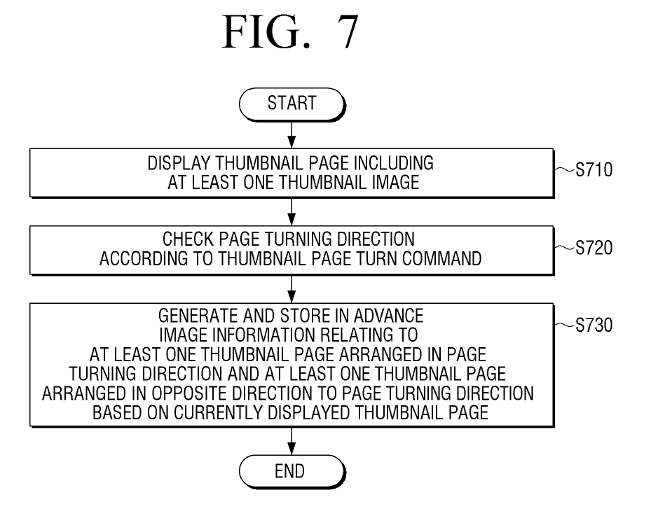

FIG. 7 is a flowchart which illustrates a method of controlling a display apparatus in accordance with an exemplary embodiment.

According to a control method for a display apparatus illustrated in FIG. 7, a thumbnail page including at least one thumbnail image may be displayed (S710).

Afterwards, image information related to at least one thumbnail page arranged in a page turning direction and image information related to at least one thumbnail page arranged in an opposite direction to the page turning direction, based on a displayed thumbnail page, may be generated in advance and stored (S720).

A thumbnail page to be displayed according to a thumbnail page turn command may be generated based on the stored image information and then displayed (S730).

Also, image information related to a currently-displayed thumbnail page may further be stored.

In the step S720 of generating in advance and storing the image information, the image information related to the thumbnail pages may be generated and stored such that the number of thumbnail pages arranged in the page turning direction is greater than the number of thumbnail pages arranged in the opposite direction.

In response to the currently-displayed thumbnail page being the last page, the at least one thumbnail page arranged in the page turning direction may become a start page. In response to the currently-displayed thumbnail page being the start page, the at least one thumbnail page arranged in the opposite direction may become the last page.

In response to a capacity of the storage being exceeded, the controller may delete image information related to at least one thumbnail page of all the thumbnail pages, except for the currently-displayed thumbnail page and a thumbnail page to be generated in advance, from among image information related to the pre-stored thumbnail pages.

In this case, the image information relating to the thumbnail page may be at least one of uncompressed bitmap information and compressed bitmap information which corresponds to a thumbnail image constructing the thumbnail page.

In addition, an original copy of a thumbnail image may be at least one of a still image and a video.

In response to the original copy of the thumbnail image being a video, the thumbnail image may be an animation image configured by including a plurality of still images.

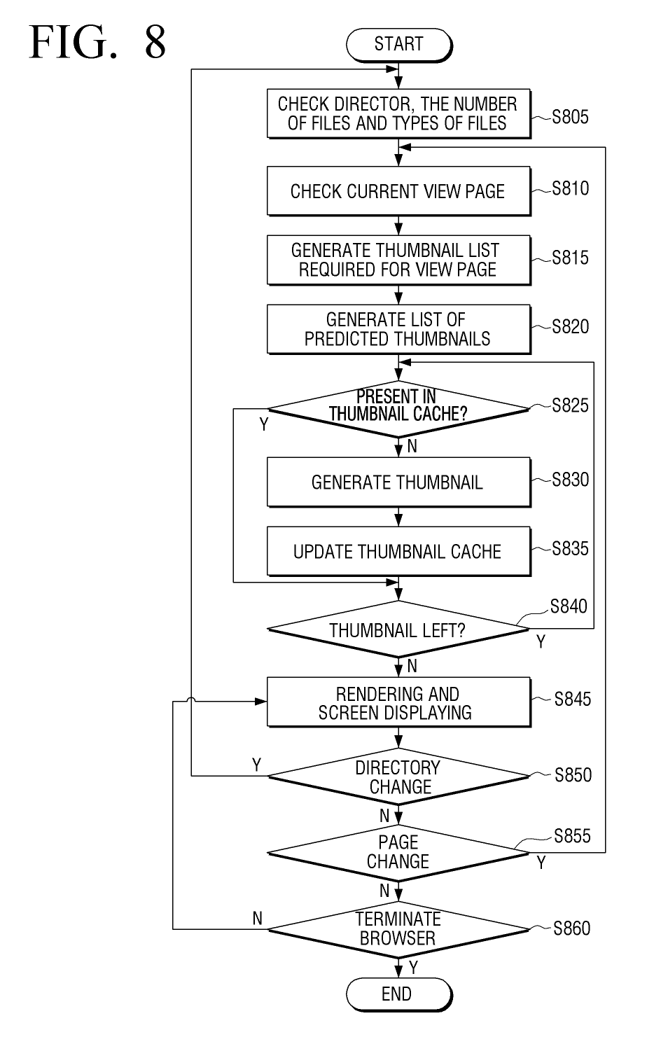

FIG. 8 is a flowchart which illustrates a method of controlling a display apparatus in accordance with another exemplary embodiment.

According to a control method for a display apparatus illustrated in FIG. 8, the number of files and types of files within a directory including an original image file may be first checked (S805).

A current view page may then be checked (S810) and a list of thumbnails required for the current view page may be generated (S815).

In addition, a list of predicted (expected) thumbnails may be generated (S820). The list of predicted thumbnails may be decided by a page turning direction, according to a user's thumbnail page turn command.

Afterwards, a check will be made as to whether or not a thumbnail image included in the list of predicted thumbnails is present in a thumbnail cache (S825).

In step S825, In response to the thumbnail image information included in the list of predicted thumbnails not being present in the thumbnail cache (S825: N), a thumbnail image may be generated (S830), and image information related to the generated thumbnail image may be stored in the thumbnail cache so as to update the thumbnail cache (S835).

In the step S825, In response to the thumbnail image information included in the list of predicted thumbnails being present in the thumbnail cache (S825: Y), the thumbnail page may be rendered using the thumbnail image information stored in the thumbnail cache so as to be displayed on a screen (S840).

Afterwards, when the directory has been changed (S845: Y), the steps S805 to S840 may be repetitively executed. When the directory has not been changed (S845: N), whether or not a page change has occurred may be checked (S850).

In the step S850, when the page has been changed (S850: Y), the steps S805 to S840 may be repetitively executed. When the page has not been changed (S850: N), whether or not to terminate the thumbnail browser may be checked (S855).

When the thumbnail browser is terminated (S860: Y), the whole process may be terminated. When the thumbnail browser is not terminated (S860: N), the steps S845 to S855 may be repeated. That is, the directory change, the page change, the termination and the like may be checked.

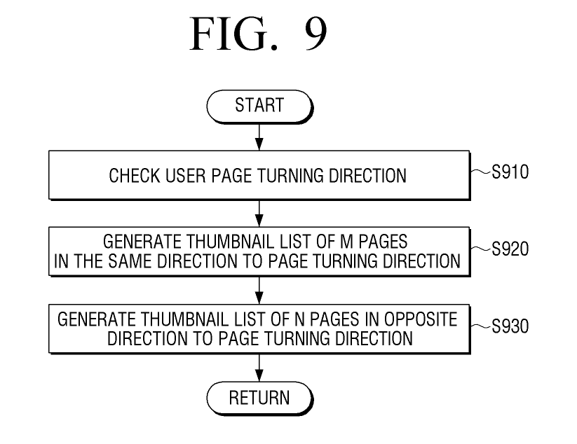

FIG. 9 is a detailed flowchart which illustrates a step of generating the list of predicted (expected) thumbnails shown in FIG. 8.

As illustrated in FIG. 9, a page turning direction according to a page turn command may be checked (S910).

A list of thumbnails for m thumbnail pages in the same direction as the page turning direction may be generated (S920).

A list of thumbnails for n thumbnail pages in an opposite direction to the page turning direction may then be generated (S930).

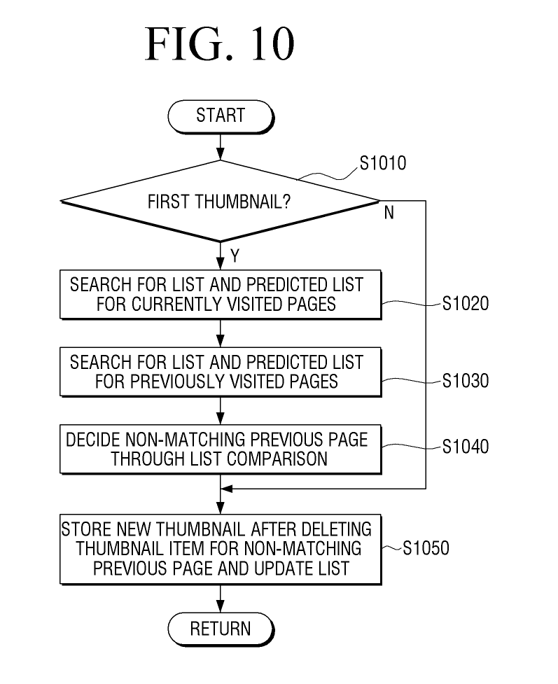

FIG. 10 is a detailed flowchart which illustrates a step of updating the thumbnail cache shown in FIG. 8.

As illustrated in FIG. 10, whether or not a displayed thumbnail is a start thumbnail, namely, a first page may be checked (S1010).

In response to the displayed thumbnail page being the first thumbnail page, a list of currently-visited pages and a predicted list on the currently-visited pages may be searched for (S1020). For example, when total pages are 6 (pages A to F) and the currently-visited page is the first page A, the last page F and the second page B may be included in the predicted list of the currently-visited page.

In addition, a list of previously-visited pages and a predicted list of the previously-visited pages may be searched for (S1030). For example, in response to the previously-visited page being the last page F, the fifth page E and the first page A may be included in the predicted list of the previously-visited page.

Each predicted list may be compared to decide non-matching previous pages (S1040). For example, the predicted list including the current page may include pages F, A and B and the predicted list including the previously-visited page may be E, F and A. Therefore, the non-matching previous page may be the page E.

Afterwards, a new thumbnail may be stored after deleting a thumbnail item of the non-matching previous page and the list may be updated (S1050). For example, a new thumbnail page may be stored after deleting the page E.

As described above, since thumbnail bitmaps are extracted and stored in advance by predicting a user's page turning direction, the thumbnail can be displayed fast on a screen. Also, upon storing the thumbnail in a cache, compressed bitmap data may be stored as is, which may allow the cache to be less used. This may result in improved user convenience.

Meanwhile, the control method for the display apparatus according to various exemplary embodiments may be implemented in program codes executable by computers and then provided to each server or device so as to be executed by a processor in a state of being stored in various non-transitory computer readable storage media.

As one example, there may be provided a non-transitory computer readable storage medium, which stores a program for executing a step of generating and storing in advance image information relating to at least one thumbnail page arranged in a page turning direction and at least one thumbnail page arranged in an opposite direction to the page turning direction, based on a displayed thumbnail page, and generating a thumbnail page to be displayed according to a thumbnail page turn command, based on the stored image information.

The non-transitory computer readable medium may be a medium, which stores data semi-permanently and is readable by a device, not a medium storing data for brief moment such as a register, cache, or a RAM memory etc. Specifically, various applications and programs described above may be provided by being stored in the non-transitory computer readable storage medium such as a CD, a DVD, a hard disk, a Bluray Disk™, an USB, a memory card, a ROM, etc.

Also, the foregoing preferred exemplary embodiments have been illustrated, but the present disclosure may not be limited to the aforementioned exemplary embodiments. Those skilled in the art will appreciate that various modifications, additions and substitutions are possible, without departing from essential characteristics of the disclosure, and those modifications and additions should not be construed individually from the technical scope or aspects of this disclosure.

What is claimed is:

1. A display apparatus comprising:
a display configured to display a thumbnail page including at last one thumbnail image;
a user interface configured to receive a thumbnail page turn command;
a storage; and
a controller configured to generate and store in advance image information relating to at least one thumbnail page arranged in a page turning direction and at last one thumbnail page arranged in an opposite direction to the page turning direction, based on a currently-displayed thumbnail page, and generate a thumbnail page to be displayed according to the thumbnail page turn command based on the image information stored in the storage.

2. The apparatus of claim 1, wherein the controller is further configured to store image information relating to the currently-displayed page in the storage.

3. The apparatus of claim 1, wherein the controller is configured to store and generate the image information related to the thumbnail pages such that the number of thumbnail pages arranged in the page turning direction is greater than the number of thumbnail pages arranged in the opposite direction.

4. The apparatus of claim 1, wherein the at least one thumbnail page arranged in the page turning direction is a start page when the currently-displayed thumbnail page is the last page, and the at least one thumbnail page arranged in the opposite direction is the last page when the currently-displayed thumbnail page is the start page.

5. The apparatus of claim 1, wherein in response to a capacity of the storage unit being exceeded, the controller is configured to delete image information related to at least one thumbnail from among of all the thumbnail pages, except for the currently-displayed thumbnail page and a thumbnail page to be generated in advance, from among image information related to the pre-stored thumbnail pages.

6. The apparatus of claim 1, wherein the image information relating to the thumbnail page is at least one of uncompressed bitmap information and compressed bitmap information which correspond to a thumbnail image constructing the thumbnail page.

7. The apparatus of claim 1, wherein an original copy for the thumbnail image is at least one of a still image and a video.

8. The apparatus of claim 7, wherein the thumbnail image is an animation image constructed by including a plurality of still images in response to the original thumbnail image being a video.

9. The apparatus of claim 1, wherein the controller is configured to sequentially generate thumbnail images configured as a thumbnail page, which is to be displayed according to the thumbnail page turn command, in a row unit or in a column unit.

10. The apparatus of claim 1, further comprising a communicator configured to execute communication with an external device,
wherein the controller is configured to generate image information relating to the thumbnail page by sequentially receiving at least part of image data, which is required to generate the image information relating to the thumbnail image, from among original image data stored in the external device.

11. A control method for controlling a display apparatus, the method comprising:
displaying a thumbnail page including at least one thumbnail image;
generating and storing in advance image information relating to at least one thumbnail page arranged in a page turning direction and at last one thumbnail page arranged in an opposite direction to the page turning direction, based on a currently-displayed thumbnail page; and
generating and displaying a thumbnail page to be displayed according to the thumbnail page turn command, based on the stored image information.

12. The method of claim 11, further comprising storing image information relating to the currently-displayed thumbnail page.

13. The method of claim 11, wherein the generating and storing of the image information in advance is executed to generate and store the image information related to the thumbnail pages such that the number of thumbnail pages arranged in the page turning direction is greater than the number of thumbnail pages arranged in the opposite direction.

14. The method of claim 11, wherein the at least one thumbnail page arranged in the page turning direction is a start page when the currently-displayed thumbnail page is the last page, and the at least one thumbnail page arranged in the opposite direction is the last page when the currently-displayed thumbnail page is the first page.

15. The method of claim 11, further comprising deleting image information related to at least one thumbnail page from all among the thumbnail pages, except for the currently-displayed thumbnail page and a thumbnail page to be generated in advance, from among image information related to the pre-stored thumbnail pages in response to a capacity of the storage being exceeded.

16. The method of claim 11, wherein the image information relating to the thumbnail page is at least one of uncompressed bitmap information and compressed bitmap information which correspond to a thumbnail image constructing the thumbnail page.

17. The method of claim 11, wherein an original copy for the thumbnail image is at least one of a still image and a video.

18. The method of claim 17, wherein the thumbnail image is an animation image constructed by including a plurality of still images in response to the original thumbnail image being a video.

19. The method of claim 11, wherein the generating and storing of the image information relating to the thumbnail page in advance is executed to sequentially generate thumbnail images configuring a thumbnail page, which is to be displayed according to the thumbnail page turn command, in a row unit or in a column unit.

20. The method of claim 11, wherein the generating and storing of the image information relating to the thumbnail page in advance is executed to generate image information relating to the thumbnail page by sequentially receiving, through communication with an external device, at least part of image data, which is required to generate the image information relating to the thumbnail page, from among original image data stored in the external device.
